(19) United States
(12) Patent Application Publication
(10) Pub. No.: US 2013/0145675 A1
(43) Pub. Date: Jun. 13, 2013

(54) PROTECTION DEVICE FOR A FISHING LURE

(71) Applicant: Jyun-Yan Fong, Taichung City (TW)

(72) Inventor: Jyun-Yan Fong, Taichung City (TW)

(21) Appl. No.: 13/346,676

(22) Filed: Jan. 9, 2012

(30) Foreign Application Priority Data
Dec. 10, 2011 (TW) 100204631

(51) Int. Cl. A01K 85/00

(52) U.S. Cl. 43/42.36

(57) ABSTRACT

A protection device for a fishing lure includes a fishing lure and a hook-releasing unit. The hook-releasing unit can be disposed outside or inside the fishing lure. An end of the hook-releasing unit is connected to a fishing line of a fishing rod. The other end of the hook-releasing is movably connected to a cord of a fishhook. An end of the hook-releasing unit connected to the fishing line has an elastic force of a specific load. When the fishhook is hooked at the bottom of water, pulling the fishing line will generate a force larger than the elastic force of the elastic body to thereby release the hook-releasing unit from the cord of the fishhook, so that the fishing lure can be taken back. The present invention is simple in structure, easy to use, and suitable for all existing fishing lure, and protects a wide range of fishing lures.

### BACKGROUND OF THE INVENTION

1. Field of the Invention

The present invention relates to a protection device for a fishing lure, and in particular to a protection device for a fishing lure, whereby a fishhook connected to the fishing lure can be removed

2. Description of Prior Art

Fishing lure is an artificial fishing bait. The fishing lure disclosed in the conventional patents is configured to simulate a live bait as best as possible in order to attract and capture fish.

For ensnaring the fish, a conventional fishing lure employs a spring to make the fishing lure to generate vibrations, or employs an elastic auxiliary hook to generate an elastic extension or retraction motions inside/outside the fishing lure. However, the conventional fishing lures have the following problems.

When fishing by using fishing lures, since fishhooks are fixedly connected to the fishing lure, the fishing lures often get lost if the fishhooks hook other objects or the bottom of water, which causes the lose of fishing lures to the fisherman. Further, the fishing lures made of plastic or metallic materials are left in the water (sea), which inevitably has a negative influence on the underwater environment. Therefore, the present Inventor aims to improve the drawbacks of the fishing lures in prior art.

### SUMMARY OF THE INVENTION

In order to solve the above problems, an objective of the present invention is to provide a protection device for a fishing lure. When fishing by the fishing lure and fishhooks connected to the fishing lure hook to the bottom of water, the fishhooks can be released from the bottom of water to thereby protect the fishing lure.

### BRIEF DESCRIPTION OF THE DRAWINGS

FIG. 1 is a schematic view showing that the present invention is provided on a fishing rod;

FIG. 2 is a cross-sectional view showing that the hook-releasing unit is provided outside the fishing lure in a hooked state;

FIG. 3 is another cross-sectional view showing that the hook-releasing unit is provided outside the fishing lure in a released state;

FIG. 4 is a schematic view showing that the hook-releasing unit is provided outside the fishing lure;

FIG. 5 is a cross-sectional view showing that the hook-releasing unit is provided inside the fishing lure according to a first version;

FIG. 6 is a cross-sectional view showing that the hook-releasing unit is provided inside the fishing lure according to a second version;

FIG. 7 is a cross-sectional view showing that the hook-releasing unit is provided inside the fishing lure according to a third version;

FIG. 8 is a cross-sectional view showing that the hook-releasing unit is provided inside the fishing lure according to a fourth version;

FIG. 9 is a cross-sectional view showing that the hook-releasing unit is provided inside the fishing lure according to a fifth version;

### DETAILED DESCRIPTION OF THE INVENTION

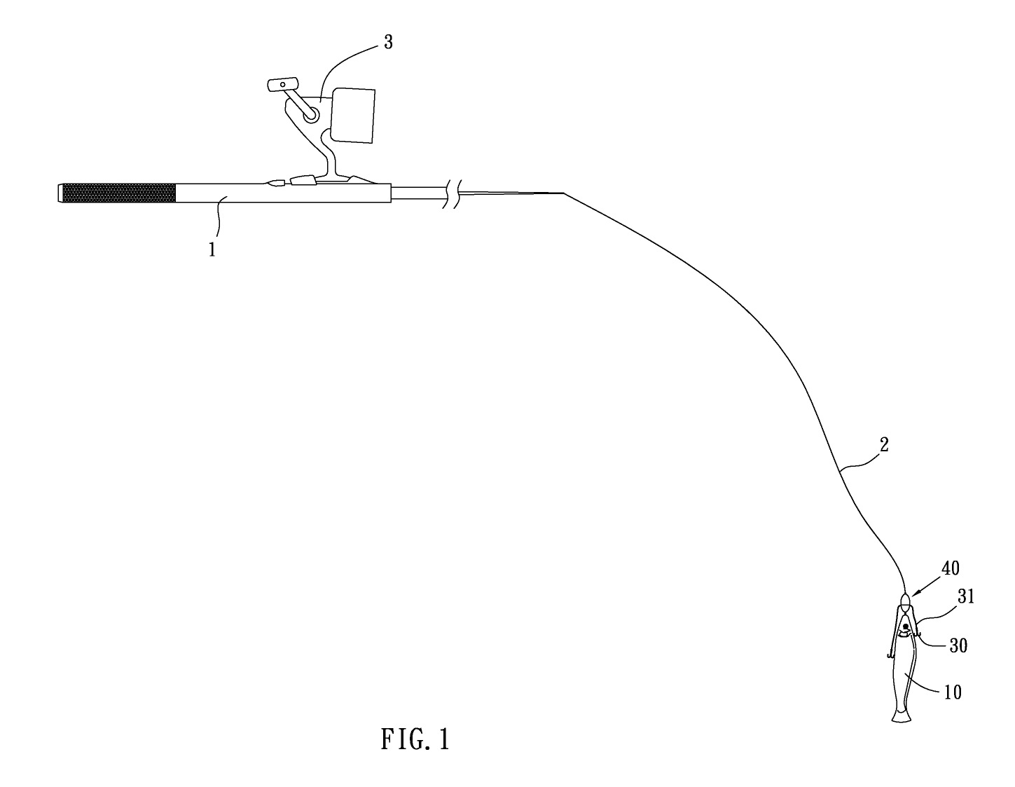

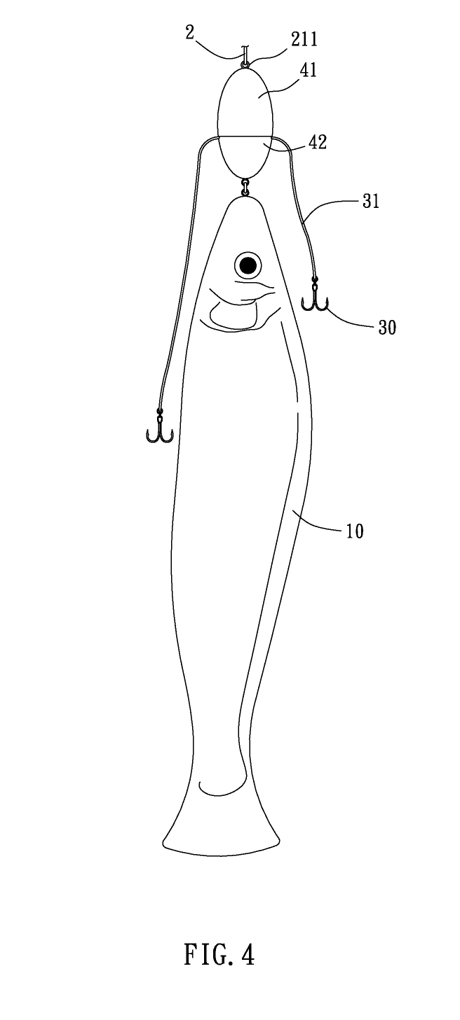

Please refer to FIGS. 1 to 9. The present invention is directed to a protection device for a fishing lure, which includes a fishing lure 10 and a hook-releasing unit 20 disposed outside or inside the fishing lure 10. By means of one end of the hook-releasing unit 20, the fishing lure 10 is connected to a fishing line 2 on a fishing rod 1. The fishing line 2 is provided on the fishing rod 1 via a fishing reel 3. The other end of the hook-releasing unit 20 is movably connected with fishhooks 30. The end of the hook-releasing unit 20 connected to the fishing line 2 has an elastic force of a specific load. The magnitude of braking force of the fishing reel 3 can be set. The fishing line 2 has variable breaking strength (maximum load before breaking) based on its material and diameter. In the present invention, the magnitude of breaking force of the fishing reel 3 is set to be smaller than the elastic force of the hook-releasing unit 20, and the elastic force is smaller than the breaking strength of the fishing line 2.

The constituents of the hook-releasing unit 20 and the structure of the hook-releasing unit 20 assembled with the fishing lure 10 will be described as follows.

The hook-releasing unit 20 is constituted of a shaft rod 21 and an elastic body 22. One end of the shaft rod 21 is provided with a fixing portion 211 for allowing the fishing line 2 to be fixed thereto. The other end of the shaft rod 21 is formed with at least one pivotal section 212. The middle section of the shaft rod 21 is provided with a stopping portion 213. The elastic body 22 is a compression spring put on the shaft rod 21 to abut against the stopping portion 213. When the shaft rod 21 is pulled to compress the elastic body 22, the compressed elastic body 22 exerts an elastic force of a specific load to the hook-releasing unit 20 while the pivotal section 212 is movably connected to the fishhook 30. One end of the fishhook 30 is provided with a cord 31 and the cord 31 winds to form a loop. The fishhook 30 is connected to the shaft rod 21 via the loop 32 of the cord 31.

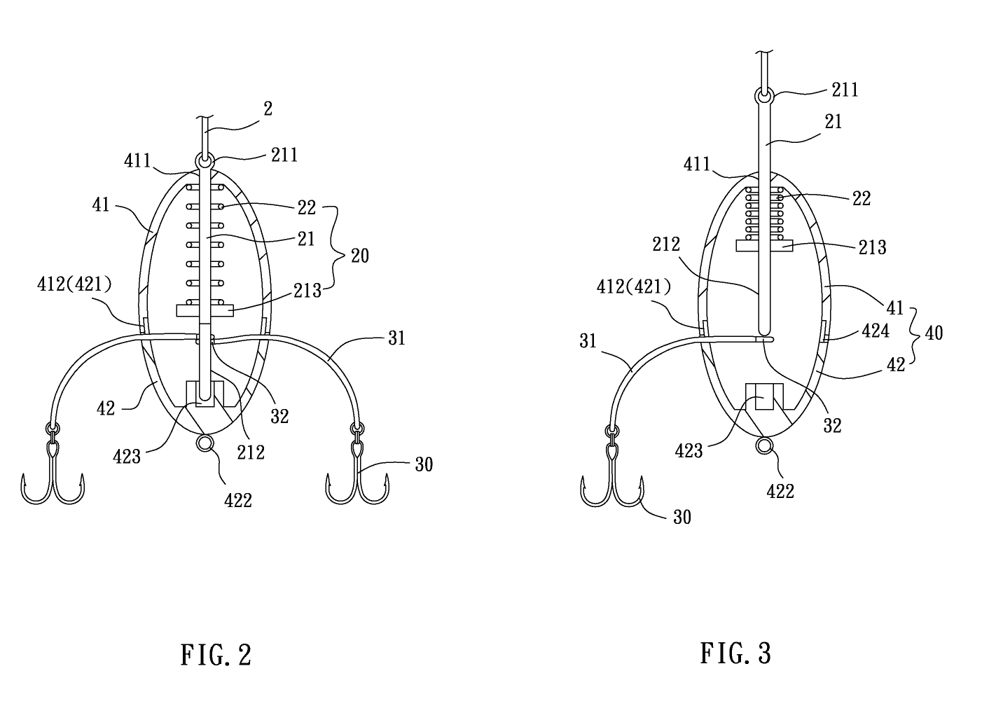

As shown in FIGS. 2 to 4, in the present embodiment, the hook-releasing unit 20 of the present invention is disposed outside the fishing lure 10. More specifically, the hook-releasing unit 20 is connected to the fishing lure 10 by using a unit body 40. The unit body 40 is formed into an egg shape and constituted of a first casing 41 and a second casing 42 assembled with each other. Both of the first casing 41 and the second casing 42 are formed into a semi-elliptical shape. An end edge of the first casing 41 is provided with a through-hole 411, and an inner peripheral surface of the other end of the first casing 41 is provided with a first combining portion 412. An outer peripheral surface of one end of the second casing 42 corresponding to the first casing 41 is provided with a second combining portion 421, and the other end of the second casing 42 is provided with a connecting portion 422 for connecting the fishing lure 10. The interior of the end of the second casing 42 having the connecting portion 422 is provided with a restricting base 423. The peripheral surface of the second casing 42 corresponding to the second combining portion 421 is further provided with a plurality of trough holes 424 in communication with the inner edge of the second casing 42. In the present embodiment, the first combining portion 412 and the second combining portion 421 are embodied as inner threads and outer threads respectively.

When the hook-releasing unit 20 is assembled with the inner edge of the unit body 40, the shaft rod 21 is disposed through the through-hole 411 with its pivotal section 212 being located in the second casing 42. After the elastic body 22 is put on the shaft rod 21, both ends of the elastic body 22 abut against the stopping portion 213 and the inner wall of the first casing 41. One end of the loop 32 of the cord 31 is disposed through the trough holes 424 on the outer peripheral surface of the second casing 42, and the pivotal section 212 of the shaft rod 21 is disposed through the loop 32 to be wedged into the restricting base 423, thereby movably connecting the fishhooks 30.

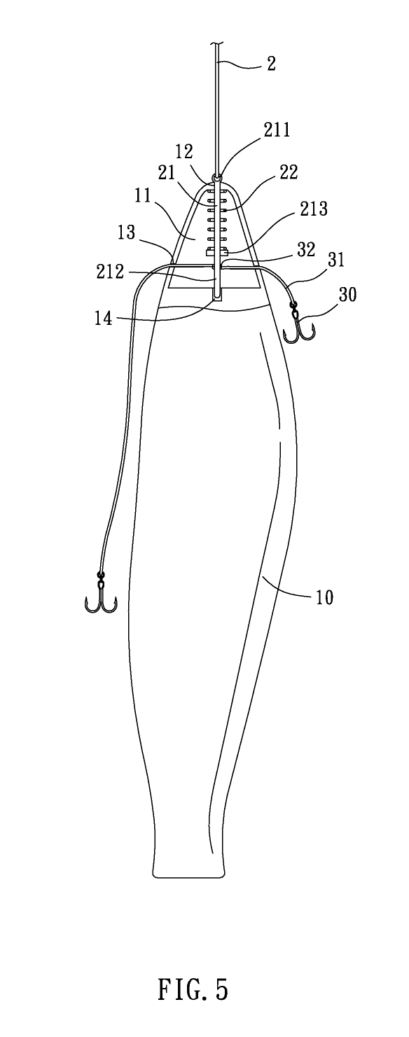

Please refer to FIGS. 5 to 9 showing another embodiment of the present invention, in which the hook-releasing unit 20 is disposed inside the fishing lure 10. The fishing lure 10 is assembled or integrally formed in an accommodating space 11. The outer surface of the fishing lure 10 is provided with a through-hole 12 and a plurality of trough holes 13 in communication with the accommodating space 11. The inner wall of the accommodating space 11 opposite to the through-hole 12 is provided with a restricting base 14. It is apparent that the positions of the internal accommodating space 11 and the trough holes 13 as well as the construction of the shaft rod 21 may be varied based on the outer profile of the fishing lure 10 and the working sites.

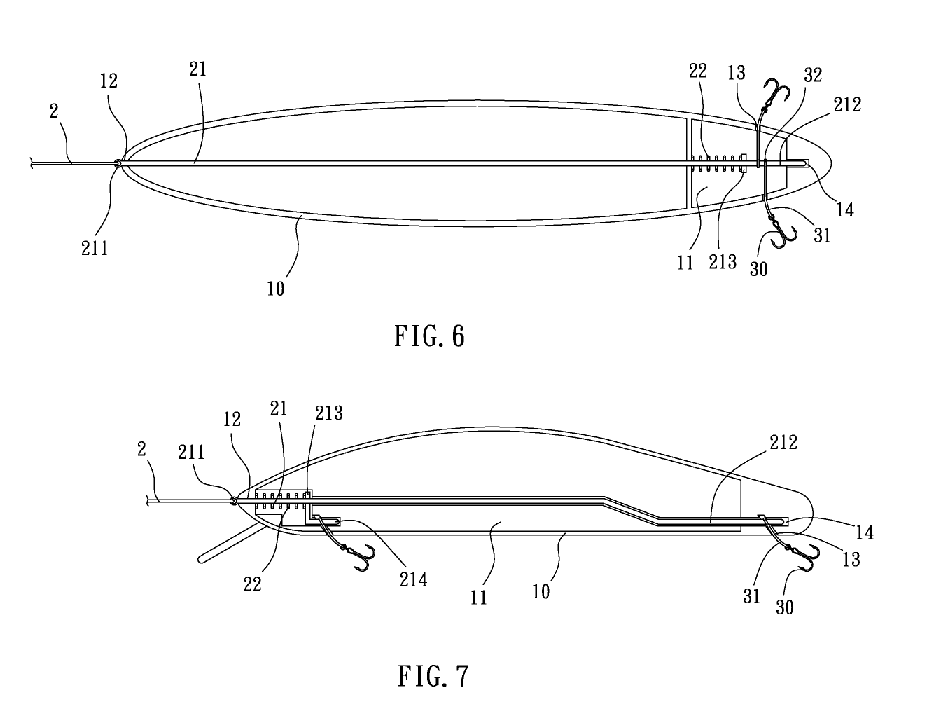

As shown in FIGS. 5 and 6, when the hook-releasing unit 20 is provided at the front end or rear end of the fishing lure 10, the shaft rod 21 has a crisscross shape. In assembly, the shaft rod 21 is disposed through the through-hole 12 with its pivotal section 212 being located in the accommodating space 11 and its end being disposed in the restricting base 14. Then, the elastic body 22 is put on the shaft rod 21 with its two ends abutting against the stopping portion 213 and the inner wall of the accommodating space 11. One end of the loop 32 of the cord 31 is disposed into the accommodating space 11 via the trough holes 13. Then, the pivotal section 212 of the shaft rod 21 is disposed through the loop 32 to be wedged into the restricting base 14, thereby movably connecting the fishing lure 30.

In order to fit the position of the fishing lure 30, the shaft rod 21 of the hook-releasing unit 20 can be designed as a different shape to be disposed in both ends of the accommodating space 11. In addition to the pivotal section 212 extending from one end of the shaft rod 21, the other end of the shaft rod 21 may be provided with a second pivotal section 214.

As shown in FIG. 7, the shaft rod 21 is substantially formed in an “h” shape. The stopping portion 213 is formed into a flat plate. The second pivotal section 214 extends from the outer edge of the stopping portion 213. The second pivotal section 214 and the stopping portion 213 form an L-shaped structure.

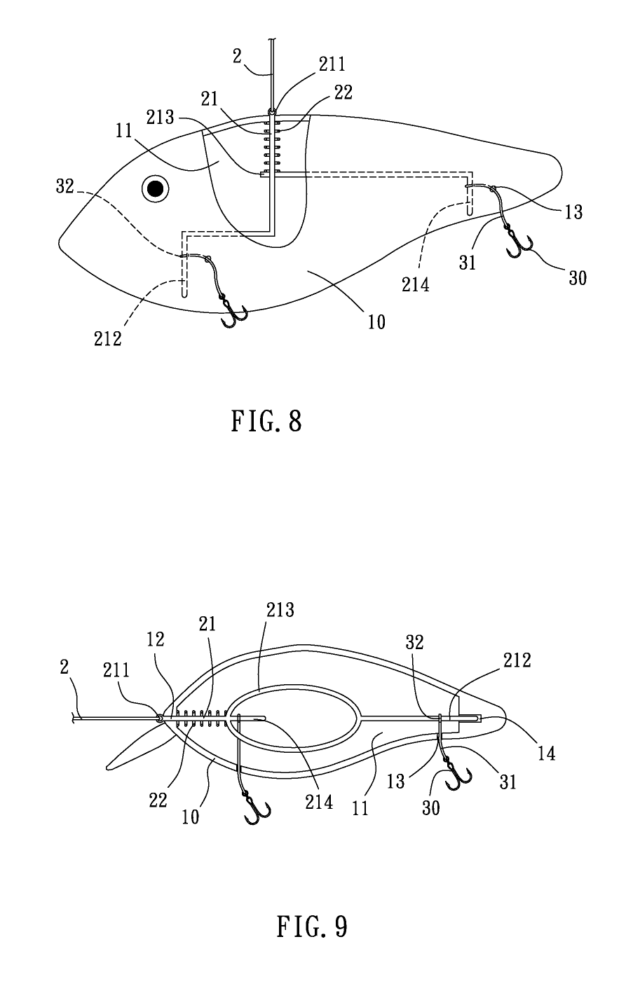

As shown in FIG. 8, the shat rod 21 is substantially formed into “m” shape. The stopping portion 213 is formed with a flat plate. The second pivotal section 214 extends from the outer edge of the stopping portion 213. The second pivotal section 214 and the stopping portion 213 form an L shape. The pivotal section 212 is bent by ninety degrees to form a N shape, whereby the fishhook 30 can be disposed aside the fishing lure 10.

As shown in FIG. 9, the shaft rod 21 is formed into an elongate shape. The stopping portion 213 is formed into a frame of a geometrical shape and the second pivotal section 214 protrudes into the frame of the stopping portion 213.

When the hook-releasing unit 20 is assembled in the accommodating space 11 of the fishing lure 10, the shaft rod 21 is disposed through the through-hole 12 with its pivotal section 212 and the second pivotal section 214 being located in the accommodating space 11. One end of the shaft rod is disposed in the restricting base 14. When the elastic body 22 is put on the shaft rod 21, both ends of the elastic body 22 abut against the stopping portion 213 and the inner wall of the accommodating space 11. The trough holes 13 are provided near on the fishing lure 10 near the pivotal section 212 and the second pivotal section 214, so that an end of the loop 32 of the cord 31 can be disposed into the accommodating space 11 via the trough holes 13. After the pivotal shaft 222 and the second pivotal section 214 of the shaft rod 21 are disposed into the corresponding cord 32 respectively, the shaft rod 21 can be moveably connected to the fishhook 30.

By the above-mentioned constituents, since the hook-releasing unit 20 is assembled with the fishing lure 10 and movably connected to the fishhook 30, when the fishhooks 30 are hooked at the bottom of water or an unmovable object, pulling the fishing line 2 will generate a force larger than the elastic tension force of the elastic body 22 to compress the elastic body 22 to thereby release the pivotal section 212 and the second pivotal section 214 from the loop 32 of the cord 31, so that the fishing lure 10 can be released from the fishhooks 30 (FIG. 3) and thus the fishing lure 10 can be taken back. The present invention is simple in structure, easy to use, and suitable for all existing fishing lures, whereby a wide range of fishing lures can be protected. On the other hand, since the fishing lures can be taken back without leaving in natural environment, our environment can be protected.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A protection device for a fishing lure, including a fishing lure and a hook-releasing unit assembled with the fishing lure, wherein an end of the hook-releasing unit is connected to a fishing line on a fishing rod, the other end of the hook-releasing unit is movably connected to a cord on an end of a fishhook, an end of the hook-releasing unit connected to the fishing line is provided with an elastic body having a specific elastic force,
when the fishhook is hooked by an object and unable to be released, pulling the fishing line will generate a pulling force to compress the elastic body to thereby release the hook-releasing unit from the cord so as to take back the fishing lure.

2. The protection device for a fishing lure according to claim 1, wherein a braking force of the fishing line on a fishing reel is smaller than the elastic force of the elastic body of the hook-releasing unit and the elastic force is smaller than a breaking strength (maximum load) of the fishing line when the fishing line is provided on the fishing rod via the fishing reel.

3. The protection device for a fishing lure according to claim 1, wherein the hook-releasing unit is detachably provided outside the fishing lure, the hook-releasing unit is provided in a unit body and constituted of a shaft rod and the elastic body, one end of the shaft rod is provided with a fixing portion for allowing the fishing line to be fixed thereto, the other end of the shaft rod is provided with a pivotal section, a middle section of the shaft rod is provided with a stopping portion, the unit body is constituted of a first casing and a second casing, an end of the first casing is provided with through-holes, the other end of the first casing is provided with a first combining portion, an end of the second casing opposite to the first casing is provided with a second combining portion, the other end of the second casing is provided with a connecting portion for connecting the fishing lure, the end of the second casing having the connecting portion is provided with a restricting base, a peripheral surface of the second casing corresponding to the second combining portion is provided with a plurality of trough holes, the shaft rod is disposed into the through-hole with the pivotal section being located in the second casing, the elastic body is put on the shaft rod, both ends of the elastic body abut against the stopping portion and an inner wall of the first casing, an end of the cord connected to the fishhook winds to form a loop, an end of the loop of the cord is disposed in the second casing via the trough hole, the pivotal section of the shaft rod is disposed through the loop to be wedged into the restricting base, thereby movably connecting the fishhook,
when the fishhook is hooked at the bottom of water, pulling the fishing line will generate a force larger than the elastic tension force of the elastic body to compress the elastic body to thereby release the pivotal section from the loop of the cord, so that the fishing lure can be separated from the fishhook.

4. The protection device for a fishing lure according to claim 1, wherein the hook-releasing unit is disposed inside the fishing lure and constituted of a shaft rod and the elastic body, one end of the shaft rod is provided with a fixing portion for allowing the fishing line to be fixed thereto, the other end of the shaft rod is provided with a pivotal section, a middle section of the shaft rod is provided with a stopping portion, the fishing lure is assembled together, an accommodating space is formed in an end of the fishing lure, a through-hole and a plurality of trough holes are provided on an outer surface of the fishing lure in communication with the accommodating space, an inner wall of the accommodating space opposite to the through-hole is provided with a restricting base, the shaft rod is disposed in the through-hole with the pivotal section being located in the accommodating space and one end of the shaft rod being disposed into the restricting base, the elastic body is put on the shaft rod, both ends of the elastic body abut against the stopping portion and the inner wall of the accommodating space, a section of the cord winds to form a loop, an end of the loop is disposed into the accommodating space via the trough hole, the pivotal section of the shaft rod is disposed into the loop to be wedged into the restricting base, thereby movably connecting a fishhook,
when the fishhook is hooked to the bottom of water, pulling the fishing line will generate a force larger than the elastic tension force of the elastic body to compress the elastic body to thereby release the pivotal section from the loop of the cord, so that the fishing lure can be separated from the fishhook.

5. A protection device for a fishing lure, including a fishing lure and a hook-releasing unit assembled with the fishing lure, wherein an end of the hook-releasing unit is connected to a fishing line on a fishing rod, the other end of the hook-releasing unit is movably connected to a cord on an end of a fishhook, the hook-releasing unit is disposed inside the fishing lure and constituted of a shaft rod and an elastic body, one end of the shaft rod is provided with a fixing portion for allowing the fishing line to be fixed thereto, the other end of the shaft rod is provided with at least one pivotal section, a stopping portion is provided adjacent to the pivotal section, an accommodating space is formed in the fishing lure, a trough hole is provided on an outer surface of the fishing lure in communication with its interior, the pivotal section of the shaft rod is located in the accommodating space of the fishing lure, the fixing portion is provided outside the though-hole, the elastic body is put on an end of the shaft rod adjacent to the through-hole, both ends of the elastic body abut against the stopping portion and the inner wall of the accommodating space, a section of a cord winds to form a loop, an end of the loop is disposed into the accommodating space via the trough hole, the pivotal section of the shaft rod is disposed into the loop to thereby movably connect a fishhook,
when a fishhook is hooked to the bottom of water, pulling the fishing line will generate a force larger than the elastic tension force of the elastic body to compress the elastic body to thereby release the pivotal section from the loop of the cord, so that the fishing lure can be separated from the fishhook and thus the fishing lure can be taken back.

6. The protection device for a fishing lure according to claim 5, wherein an inner wall of the accommodating space of the fishing lure corresponding to the pivotal section is provided with a restricting base for allowing and an end of the pivotal section to be inserted therein.

7. The protection device for a fishing lure according to claim 5, wherein the stopping portion of the shaft rod is formed into a flat plate, an end of the shaft rod is provided with a second pivotal section, the second section and the stopping portion forms an L shape, an outer surface of the fishing lure corresponding to the second pivotal section is provided with a trough hole in communication with the interior of the fishing lure, another fishhook is provided on the second pivotal section via the trough hole.

8. The protection device for a fishing lure according to claim 5, wherein the stopping portion of the shaft rod is formed into a flat plate, an end of the shaft rod is provided with a second pivotal section, the second pivotal section and the stopping portion forms an L shape, the pivotal section is bent by ninety degrees to form a N shape to correspond to the location of the fishhook, an outer surface of the fishing lure corresponding to the second pivotal section is provided with a trough hole in communication with the interior of the fishing lure, another fishhook is provided on the second pivotal section via the trough hole.

9. The protection device for a fishing lure according to claim 5, wherein the stopping portion of the shaft rod is formed into a frame having a geometric shape, the interior of the stopping portion is provided with a second pivotal section, the second pivotal section protrudes into the frame of the stopping portion, an outer surface of the fishing lure corresponding to the second pivotal section is provided with a trough hole in communication with the interior of the fishing lure, another fishhook is provided to the second pivotal section via the trough hole.
